(19) United States
(12) Patent Application Publication
(10) Pub. No.: US 2003/0217799 A1
(43) Pub. Date: Nov. 27, 2003

(54) Method for drying sheets of plasterboard and device for implementing it

(76) Inventor: Charles Falinower, Carpentras (FR)

Correspondence Address: BURNS, DOANE, SWECKER & MATHIS, L.L.P., P.O. Box 1404, Alexandria, VA, 22313-1404, US

(21) Appl. No.: 10/429,833

(22) Filed: May 6, 2003

Related U.S. Application Data
(63) Continuation-in-part of application No. PCT/FR01/03408, filed on Nov. 5, 2001.

(30) Foreign Application Priority Data
Nov. 8, 2000 (EP) 00403098.7

(51) Int. Cl. B32B 31/14

(52) U.S. Cl. 156/45; 156/346

(57) ABSTRACT

A method for manufacturing sheets of plasterboard includes forming the sheet; setting the sheet with hydration; and drying while the sheet is being rotated. A barrel is used for drying.

### CROSS-REFERENCE TO RELATED APPLICATIONS

The present application is a continuation-in-part of PCT/FR01/03408, filed in France on Nov. 5, 2001, and claims the priority of European Application No. 00403098.7, filed on Nov. 8, 2000. The entire contents of both applications are incorporated herein by reference.

### BACKGROUND OF THE INVENTION

1. Field of the Invention

The subject of the invention is a novel method for manufacturing sheets of plasterboard, and a device for implementing it.

2. Description of Related Art

Sheets of plasterboard are known and consist of a dense (density for example 0.6 to 1.0, generally approximately 0.7) core of plaster or stucco on at least one support of the paper type, and preferably between two supports of the paper type (typically one of them being known as the ivory paper, or “face”, and the other as the grey paper, or “back”). The conventional method for manufacturing such sheets of plasterboard comprises the following steps. Typically, the method comprises forming the sheet, this step comprising the sub-steps of rolling out the ivory paper, mixing to obtain a paste made up mainly of plaster (semi-hydrate) and of water, to which additives are added in order to give the sheet specific usage properties (particularly starch and possibly a foaming agent is (are) added in order to form a foam); depositing the said paste on the ivory paper; rolling out then applying the grey paper to form, continuously, the sandwich that is the precursor of the sheet; hydration, setting and cohesion of the paste during hydration with the two papers on supports that constitute the forming line. At the end of the forming line, the product is in a semi-finished state capable of being cut by shears, then handled, possibly in particular with a turning-over, or flipper, operation in order to place it ivory face uppermost. Finally, this product is introduced into a drier to eliminate the excess water from the sheet (an operation known as drying the sheet). On leaving the drier, the sheet is subjected, in the dry state, to various conditioning treatments to give it its final presentation.

While each step has its own technical problems, certain steps are critical, either in terms of the kinetics of the chemical reaction, or in terms of kinematics or of the method and which will influence the properties and quality of the end product, or in terms of the complexity and size of the apparatus and of the difficulty of maintenance, and of the occupation of space, or in terms of several in combination. The steps which are the most critical, apart from the initial forming step, are the hydration-setting steps; transfer in the wet state and drying in the drier to eliminate the excess free water. In fact, each major step in the method of manufacturing sheets of plasterboard is critical to the method and/or to the end product. Such a degree of criticality is specific to the method for manufacturing sheets of plasterboard.

The step from the beginning of hydration as far as the shearing operation conventionally lasts a few minutes, typically about 3 to 4 minutes or more, and the next stage of wet transfer and end of hydration up to the entry into the drier lasts from 5 to 10 minutes. When it is desirable to increase the speed of the line, in order to achieve values in excess of 150 m/min, with conventional hydration times, it then becomes necessary to increase the length of the forming line to values in excess of 500 m, something which is extremely expensive and presents numerous problems of kinematics and of transferring and positioning the sheets on the machines.

The step of transfer in the wet state employs complex devices which have to operate in a hot and damp atmosphere. The productivity of the production line is therefore dependant upon the reliability of these devices, which are tricky and expensive to maintain.

Moreover, these conventional devices give rise, by construction, to hydration times which differ in the longitudinal direction of the sheet, on the one hand, and to offsets between runs of sheets, on the other hand, prior to entry into the drier, all of which have to be got around using complicated systems. It is then necessary to compensate for these offsets in order to obtain uniform drying across the entire area of the sheets, particularly at the ends of the sheets. The mechanism has to make sure that the sheets do not break up at their ends and do not overlap. In order to achieve this in the prior art, it has proved indispensable to employ highly complex mechanical systems and to regulate the speeds of numerous motors.

The drying step entails mechanical devices which have to operate in a damp environment which may be as damp as being saturated with water vapour, and may reach several hundreds of ° C., something which once again raises problems with maintenance.

Finally, the drying step consumes a great deal of energy and it would be advantageous to have a method and device for drying which makes it possible to supply the sheets with only the amount of heat energy they require.

The other steps of the method also raise other problems, which also need to be solved as best possible. For example, the shearing step employs shears in the form of two rollers fitted with blades which have to be cleaned regularly. This device is quite destructive and mechanically harsh on the sheet (this is also one of the reasons which make it necessary to have a relatively long setting time because the—hydrated—set wet sheet has to be able to withstand the stresses imposed by the shears and the handling operations in the wet transfer zone).

The turning-over or flipper step has hitherto often been necessary. The tapered edges of the sheet are formed by virtue of a lower roller with thickened edges or a strip having the inverse shape; this implies having the ivory paper lowermost. Now, during subsequent drying, it is preferable for this ivory face to be on the top, so as to avoid the rollers of the drier soiling it in any way. It would be desirable to be able to avoid this penalizing flipper step (while possibly still being able, if desired, to keep the current configuration where the plaster paste is deposited on the ivory paper).

The step of transfer in the dry state admittedly raises fewer problems than encountered in the wet state, but remains complicated and the maintenance is still irksome.

### OBJECTS AND SUMMARY

An object of the invention is to provide a method and device for implementing it, which make it possible to avoid the abovementioned problems and to offer other advantages still in terms of method/quality for the end product, in terms of maintenance, in terms of operating cost, investment cost, and working conditions. The invention relies in part on the principle whereby unlike the prior art in which the sheets travel great distances through the various equipment items, in the invention, the sheets are practically stationary; it is the equipment items which move, generally in rotation.

According to a first embodiment, the subject of the invention is a method for manufacturing sheets of plasterboard comprising the following steps:

(i) forming the sheet;

(ii) setting it by hydration until a hydrated product with a content of below 80% is obtained;

(iii) continuing hydration in at least one revolving barrel; and

(iv) drying.

According to one embodiment, hydration is continued in the said at least one barrel until full hydration is reached.

According to one embodiment, hydration is continued in the said at least one barrel still to a partial extent, and then in a second barrel until full hydration is reached.

According to one embodiment, the method comprises, between steps (ii) and (iii), an intermediate shearing step.

According to one embodiment, this shearing step is carried out using the wire technique.

According to one embodiment, hydration at the end of step (ii) is below 66%.

According to one embodiment, hydration at the end of step (ii) is between 33 and 66%, preferably between 33 and 50%.

An embodiment of the invention also includes a device for manufacturing sheets of plasterboard comprising a linear zone for partial hydration-setting and at least one barrel comprising a central axis 9 about which a number of branches 10a, 10b, 10c, 10d are arranged.

According to one embodiment, in the barrel, each branch is divided into a number of arms 11a, 11b, 11c, 11d, the area occupied by the arms representing from 50 to 99% of the area of the corresponding branch.

According to one embodiment, the barrel comprises from 10 to 150, preferably from 40 to 120, branches.

According to one embodiment, the hydration-setting zone and the barrel are along two parallel axes.

According to one embodiment, the setting zone and the barrel are coupled via rollers 8a, 8b and 8c, these rollers penetrating between the branches 10a, 10b, 10c, 10d.

According to one embodiment, the device comprises a shearing device comprising a wire.

The invention also provides a barrel comprising a central axis 9 about which a number of branches 10a, 10b, 10c, 10d are arranged, each branch being divided into a number of arms 11a, 11b, 11c, 11d, the area occupied by the arms representing from 50 to 99% of the area of the corresponding branch.

According to one embodiment, the barrel comprises from 10 to 150, preferably from 40 to 120, branches.

According to a second alternative form, the subject of the invention is a method for manufacturing sheets of plasterboard comprising the following steps:

(i) forming the sheet;

(ii) setting the sheet by hydration;

(iii) drying while the sheet is being rotated.

According to one embodiment, drying is carried out in at least one barrel revolving inside a chamber.

According to one embodiment, drying is carried out in at least one barrel, the said at least one barrel comprising a single drying section.

According to one embodiment, drying is carried out in at least one barrel, the said at least one barrel comprising two distinct drying sections.

According to one embodiment, drying is carried out in at least one barrel, the said at least one barrel comprising two or more distinct drying sections.

According to one embodiment, drying is carried out in at least two barrels.

According to one embodiment, drying is carried out in at least two barrels, with drying sections which are distinct from one barrel to the next.

According to one embodiment, each barrel may comprise one, two, three or more distinct drying section(s).

According to one advantageous embodiment, drying is carried out in at least one barrel, the said at least one barrel having at least two distinct drying zones; this embodiment covers the case where two distinct drying zones are present in one and the same barrel and the case in which at least two distinct barrels comprise at least two distinct drying zones (at least one zone per at least one barrel).

According to one embodiment, drying is carried out in at least one barrel, with the latent heat of condensation of the water recuperated.

According to one embodiment, drying is carried out in at least one barrel without recuperation and in at least one barrel with recuperation.

According to one embodiment, the method furthermore comprises a step:

(iv) of cooling the sheet.

According to one embodiment, cooling is partially carried out in part of the last barrel.

An embodiment of the invention also includes a device for manufacturing a sheet of plasterboard comprising a setting and hydration zone and a barrel comprising a central axis 13 about which a number of branches 14a, 14b, 14c, 14d are arranged, the said barrel being contained in a chamber 15.

According to one embodiment, each branch is divided into a number of comb teeth.

According to one embodiment, the chamber represents a single drying section.

According to one embodiment, the chamber is divided into two distinct drying sections.

According to one embodiment, the chamber is divided into three or more distinct drying sections.

According to one embodiment, the central axis is a drum and the teeth are hollow in relation to the said drum.

According to one embodiment, the central axis is a drum and the teeth are hollow, in relation to the said drum, and pierced with holes along these.

According to one embodiment, the device comprises at least one barrel without recuperation and at least one barrel for recuperating the latent heat of condensation of the water.

According to one embodiment, the barrel has a cooling zone.

According to one embodiment, the cooling zone corresponds to a quarter of the barrel situated under the horizontal median, the chamber possibly being arranged at this zone.

According to one embodiment, the cooling zone corresponds to a quarter of the barrel situated above the horizontal median, the chamber possibly being arranged at this zone.

An embodiment of the invention also includes a barrel comprising a central axis 13 about which a number of branches 14a, 14b, 14c, 14d are arranged, each branch being divided into a number of comb teeth, the said barrel being contained in a chamber 15.

According to one embodiment, the chamber represents a single drying section.

According to one embodiment, the chamber is divided into two distinct drying sections.

According to one embodiment, the chamber is divided into three or more distinct drying sections.

According to one embodiment, the central axis is a drum and the teeth are hollow in relation to the said drum.

According to one embodiment, the central axis is a drum and the teeth are hollow, in relation to the said drum, and pierced with holes along these.

According to one embodiment, the barrel has a cooling zone.

According to one embodiment, the cooling zone corresponds to a quarter of the barrel situated under the horizontal median, the chamber possibly being arranged at this zone.

According to one embodiment, the cooling zone corresponds to a quarter of the barrel situated above the horizontal median, the chamber possibly being arranged at this zone.

According to a third alternative form, the subject of the invention is a method for cooling sheets of plasterboard by rotation in a revolving barrel, this barrel comprising a central axis 13 about which a number of branches 14a, 14b, 14c, 14d are arranged.

According to one embodiment, the method is carried out in a barrel in contact with ambient air.

According to one embodiment, the method is carried out in a barrel contained in a chamber.

According to one embodiment, the method is carried out in a quarter of the barrel situated under the horizontal median, the chamber possibly being arranged at this zone.

According to one embodiment, the method is carried out in a quarter of the barrel situated above the horizontal median, the chamber possibly being arranged at this zone.

According to a fourth alternative form, the subject of the invention is a method for handling sheets of plasterboard by rotation in a revolving barrel, this barrel comprising a central axis 13 about which a number of branches 14a, 14b, 14c, 14d are arranged.

According to one embodiment, the method is for turning the sheets over.

According to one embodiment, the method is for turning alternate sheets over.

According to one embodiment, the method is for pairing the sheets.

According to a fifth alternative form, the subject of the invention is a method for drying/baking/reacting flat objects as the said flat object rotates in at least one revolving barrel, this barrel comprising a central axis 13 about which a number of branches 14a, 14b, 14c, 14d are arranged, the said barrel being contained in a chamber 15.

According to one embodiment, each branch is divided into a number of comb teeth.

According to one embodiment, the said at least one barrel comprises a single drying section.

According to one embodiment, the said at least one barrel comprises two distinct drying sections corresponding to two sections of the chamber.

According to one embodiment, the said at least one barrel comprises three or more distinct drying sections corresponding to two sections of the chamber.

According to one embodiment, drying is carried out in at least two barrels, with drying sections which are distinct from one barrel to the next.

According to one embodiment, drying is carried out with recuperation of the latent heat of condensation of the water.

According to one embodiment, the central axis is a drum and the teeth are hollow in relation to the said drum.

According to one embodiment, the central axis is a drum and the teeth are hollow in relation to the said drum and pierced with holes along these.

According to one embodiment, cooling is carried out in part of the last drum.

According to one embodiment, the cooling zone corresponds to a quarter of the barrel situated under the horizontal median, the chamber possibly being arranged at this zone.

According to one embodiment, the cooling zone corresponds to a quarter of the barrel situated above the horizontal median, the chamber possibly being arranged at this zone.

According to one embodiment, the flat object is a sheet of wood, a plasterboard tile, a sheet or tile made of clay, cement or the like.

It is advantageous to combine the alternative forms, particularly the first and second alternative forms, the second and third alternative forms and the first, second and the third alternative forms.

### BRIEF DESCRIPTION OF THE DRAWINGS

The embodiments of the inventions are now described in greater detail in the description which follows and with reference to the appended drawings, in which:

FIG. 1 depicts a schematic view of a conventional installation;

FIG. 2 depicts an overall diagram of an embodiment according to the invention;

FIG. 3 depicts an embodiment of a revolving hydration barrel according to the invention;

FIG. 4 depicts the previous barrel, but viewed from above;

FIG. 5 depicts an alternative form of the hydration barrel according to an embodiment of the invention;

FIGS. 6a and 6b depict a drying barrel according to an embodiment of the invention;

FIGS. 7a and 7b depict a drying barrel according to an embodiment of the invention, in an exploded view and in a view from above;

FIGS. 8a and 8b depict a drying barrel according to an embodiment of the invention, capable of being used for indirect drying and/or as a heat recuperator;

FIG. 9 depicts a cooling barrel according to an embodiment of the invention;

FIG. 10 depicts a turning-over barrel according to an embodiment of the invention.

FIG. 11 depicts an alternative embodiment of a method for supplying the barrels with boards according to the invention.

### DESCRIPTION OF THE PREFERRED EMBODIMENTS

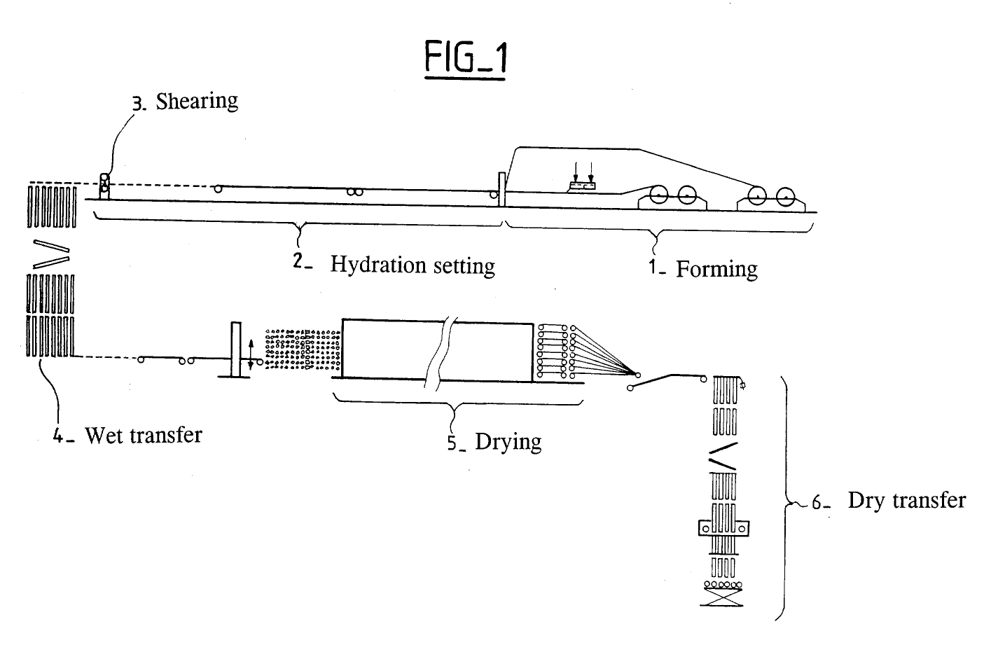

A conventional installation for the manufacture of sheets of plasterboard is described with reference to FIG. 1. Zone 1 represents the step of forming the sheet, this step comprising the sub-steps of rolling out the ivory paper, mixing, to obtain the plaster paste, depositing the paste on the ivory paper and rolling out the grey paper to form the sandwich that is the precursor of the sheet. Zone 2 represents the step of setting until a practically hydrated product is obtained. Zone 3 represents the step of shearing into individual sheets or into runs of sheet. Zone 4 represents the wet transfer step (with a turning-over operation to place the ivory face uppermost, using a device known as a flipper, and the operation of taking up offsets in runs of sheets before they enter the drier). Zone 5 represents the step of drying in a drier in order to eliminate the excess water. Zone 6 represents the step of transfer in the dry state (including possible pairing of sheets, ivory faces together, trimming, binding and packaging).

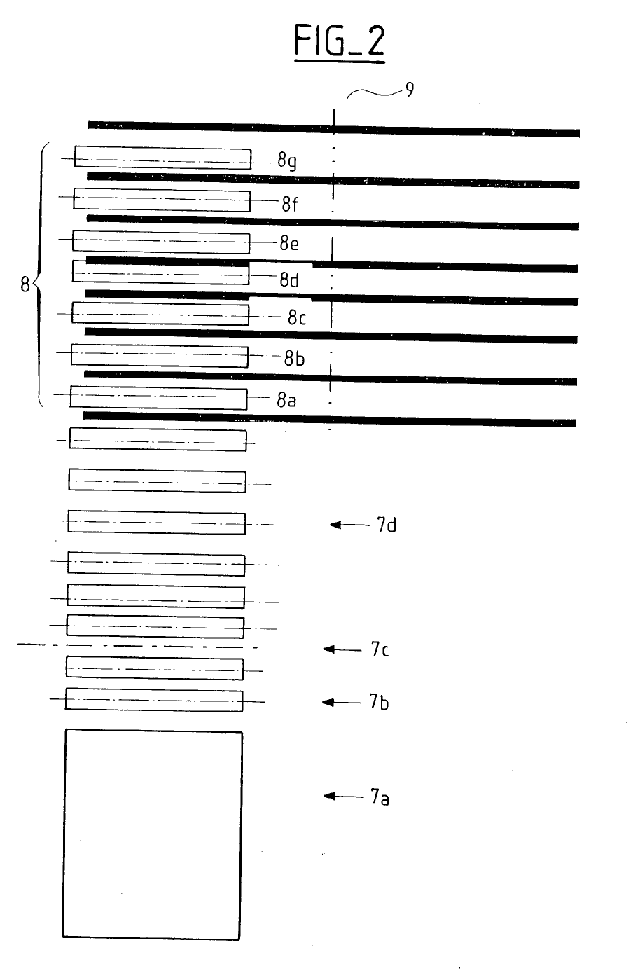

The overall diagram of a device according to the embodiment of the invention is described with reference to FIG. 2. As before, this device comprises a setting zone, during which the start of the hydration of the plaster takes place. This hydration is not continued until full hydration is achieved, but is generally continued only until at least 80% hydration is achieved, preferably until a value of between, for example, 33% and 66%, and more preferably of below 50% is achieved. The term “hydration” has the conventional meaning, namely the reaction that converts CaSO₄.0.5H₂O into CaSO₄.2H₂O. The degree of hydration is measured in the conventional way, namely measurement against a curve, which may be the rise in temperature, the gain in weight (or the uptake of water), hardening, etc. All the conventional methods are appropriate.

This setting zone is here depicted schematically by the forming strip 7a, the rollers before the shears 7b and the shears 7c itself, and the zone 7d. The zone 7d is an accelerating zone 7d (the acceleration being so as to create a space between the runs of sheet in the conventional way). This zone is coupled with a stop zone 8, which will serve as a device for introducing into a revolving barrel equipped with arms. This stop zone comprises rollers 8a, 8b, 8c, 8d, 8e, 8f, 8g, etc. These rollers are typically uniformly spaced and intended (as in the prior art) to receive the wet sheets, except that here the sheets are not as hydrated and therefore not as hard. The spacing of the rollers will be determined to prevent the sheets from sagging between these supports, something that the person skilled in the art will be able to determine with ease. Once on these rollers 8a, 8b, 8c, etc., the sheet is then picked up by the barrel 9 that is the subject of the invention.

It should be noted at this point that the shearing step may be carried out in a conventional device. It may also be carried out in a more suitable device of the “cheese wire” type. This wire may be a single or double wire, for example as if on shears. Because the degree of hydration is lower at the time of cutting, the shears can be far simpler, and do not need to be “robust”. A metal wire stretched across the line is sufficient. It may be inclined with respect to the plane of the sheet and/or to the axis of the line. It is very simple to manipulate, and the cut is cleaner. The drawbacks associated with the shears of the prior art are eliminated. This wire is very simple to clean; for example the wire could be mounted in a loop and be wound on between each cutting operation. During the winding-on operations, a very simple brush cleans the wire.

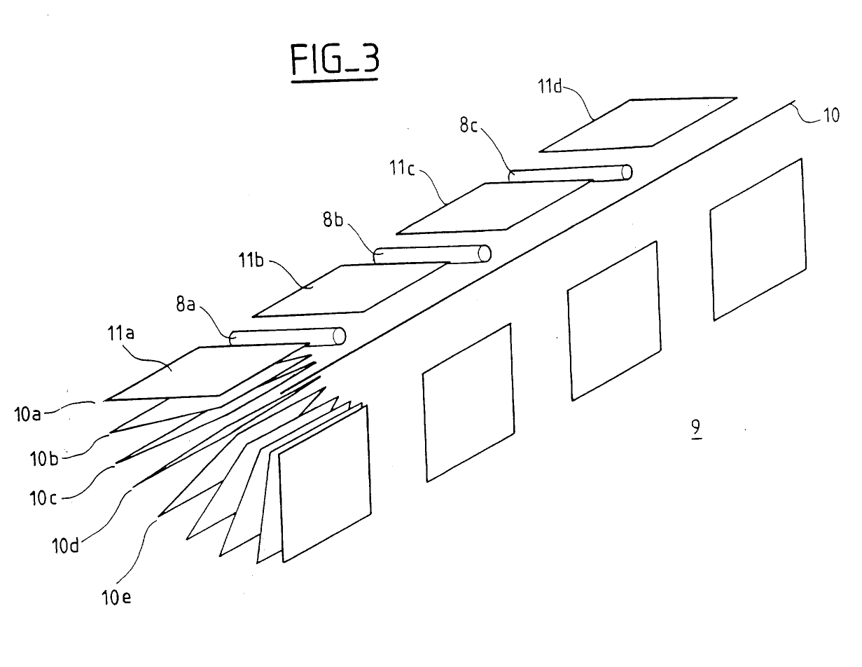

A revolving barrel according to an embodiment of the invention, intercalated with the rollers 8a, 8b, 8c described above, is described with reference to FIG. 3. The term carrousel can also be used in place of revolving barrel. The barrel is depicted with just one quadrant of the arms, in order to better show the collaboration with the rollers 8a, 8b, 8c. The barrel 9 comprises an axis 10 (generally representing a drum), to which branches 10a, 10b, 10c, 10d, 10e, etc. are fixed (the connection between the branches and the central axis is not depicted, in order to make the figure more legible). Each branch comprises several arms 11a, 11b, 11c and 11d, for example (of optimized shape) which are also relatively broad so that the sheet will set without sagging. The number of arms per branch is determined by several factors, including chiefly the speed of the line, the length of the barrel and the number of branches. This number is, for example, between 3 and 60. If we consider the area of a complete branch, the arms may, in general, represent from 50 to 90% of the area of the corresponding branch. The arms may be solid or may be holed so as both to support the sheet without allowing sag and not to slow down the phenomenon of the evaporation of the water which occurs at this stage in the method. The dimensions of the barrel are generally as follows: diameter from 3 m to 6 m, preferably from 3.5 to 4 m. As far as its length is concerned, this can very easily be adjusted to suit the production requirements. An increase in capacity is achieved by adding additional arms. Typically, the length of the barrel may be between 3 m and 25 m, or even more. If we consider a sheet of plasterboard P, this arrives on the rollers 8a, 8b, 8c (its path is controlled by mechanical and/or electrical and electronic devices). In this case, the barrel is in a position such that the sheet P can pass between the branches 10a and 10b. The barrel revolves, the arms come into contact with the wet sheet P (which has not had time to sag to any significant extent) and pick the sheet P up off the rollers, the sheet P then resting on the arms 11a, 11b, 11c and 11d of the branch 10b. The rollers therefore become free again so that they can accept another sheet P′. This sheet this time starts between the branches 10b and 10c then, after the barrel has rotated, comes into contact with the arms of the branch 10c, and so on. In this way the branches of the barrel can be “filled”. The barrel comprises, for example, from 10 to 150 branches, preferably from 40 to 120. The rotational speed of the barrel will be chosen in particular as a function of the speed of the line, the dimensions and number of branches of the barrel and of the method parameters which need to lead to complete hydration and good flatness of the sheet when it leaves the barrel. In general, the rotational speed of the barrel is between 1 rev/h (revolution/hour) and 6 rev/h, and is preferably between 4 and 6 rev/h in the case of an installation with just one hydration barrel.

The previous embodiment is described with reference to FIG. 4, viewed from above Oust one branch, the one which will pick up the sheet P, is depicted).

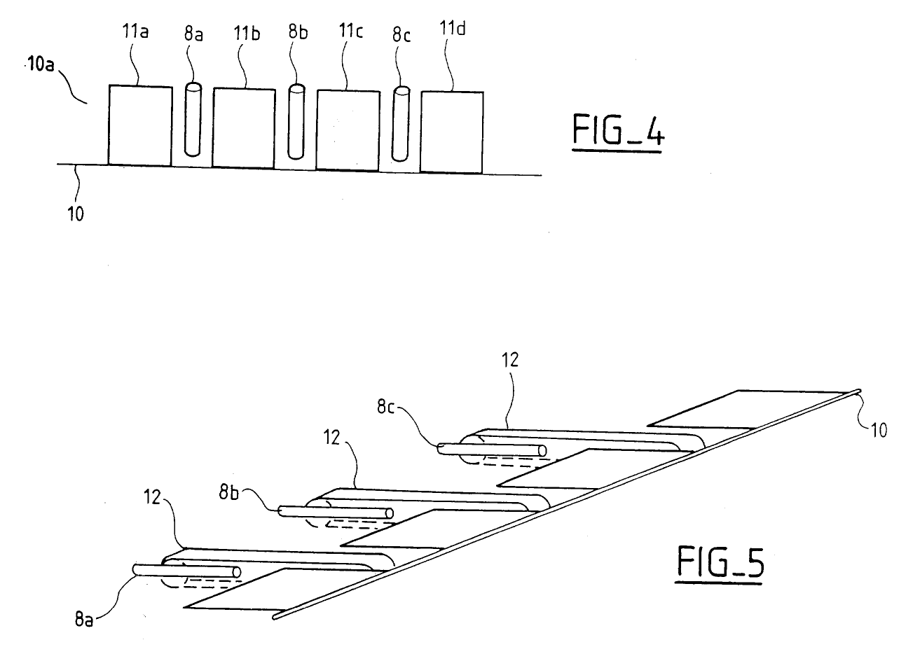

An alternative form of the previous situation is described with reference to FIG. 5. This time, the revolving barrel 9 is offset with respect to the rollers 8a, 8b and 8c. A transfer loader 12 translates the sheets from the rollers 8a, 8b and 8c towards the barrel 9. This transfer loader supplies the sheets of the run of sheets to a branch of the barrel. This transfer loader is conventionally a collection of supports joined together and which move in a translation movement then return to position from beneath, in the manner of a grouter shoe, for example, associated with an up and down movement.

It is also possible to provide the barrel directly at the end of the acceleration/stop zone, but this time with an axis no longer to parallel to but perpendicular to the direction of travel of the sheets. In this case, the axis of the sheets is perpendicular to the axis of the barrel; the latter then has a length of the order of the width of the sheet. The sheet then, at the end of travel, comes into abutment against the hub of the barrel before being manipulated by the branches of the barrel.

The hydration in the revolving barrel(s) makes it possible to save a considerable amount of space; the traditional setting section can be reduced, in length, by up to 50%. In addition, the zone for wet transfer as far as the entry to the drier is also considerably reduced. Furthermore, the residence time for each sheet in the barrel is identical, which makes it possible to have a very uniform degree of hydration of the sheets. This is all the more apparent when a drying barrel is used in conjunction with a hydration barrel.

The barrels according to an embodiment of the invention can accommodate sheets of various length, such as 1.50 m, for example, up to the total length of the barrel. This is because the arms are of sufficient width to accommodate all the lengths of sheet and all the types of run of sheets of all lengths: the sheets, irrespective of their length, will always rest sufficiently (generally, predominantly) on the arms of the barrel.

To unload the barrel, it is possible to use systems similar to those used for loading it in the alternative form illustrated in FIG. 5, namely a transfer loader. The transfer loader may comprise rollers; it may also comprise an endless belt placed between the arms, the axis of the belt being perpendicular to the axis of the barrel. In such a case, the sheet arriving on the belt is placed on top, the branches disengaging naturally. The rotational speed of the belt is therefore tailored to that of the barrel so that the latter can be emptied. Any other known system may find an application to handling the sheet in order to transfer it from one barrel to the other.

It might also be possible to have two or more hydration barrels, if necessary. The sheets are transported from one barrel to the next as above, for example.

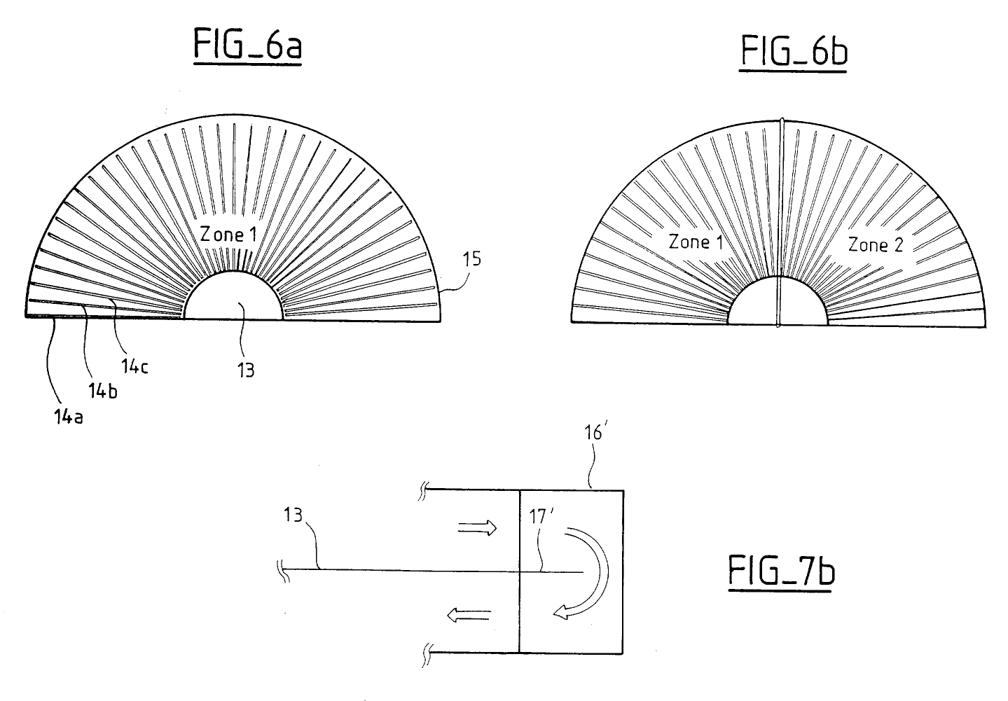

Another embodiment of the invention, namely a drier based on this principle of the revolving barrel, is described with reference to FIGS. 6a and 6b. This drier comprises an axis 13, and branches 14a, 14b, 14c, etc., all placed in a chamber 15. (Only half have been depicted). This drier of a novel type is supplied from the wet transfer according to the prior art or from a hydration barrel according to the invention described above.

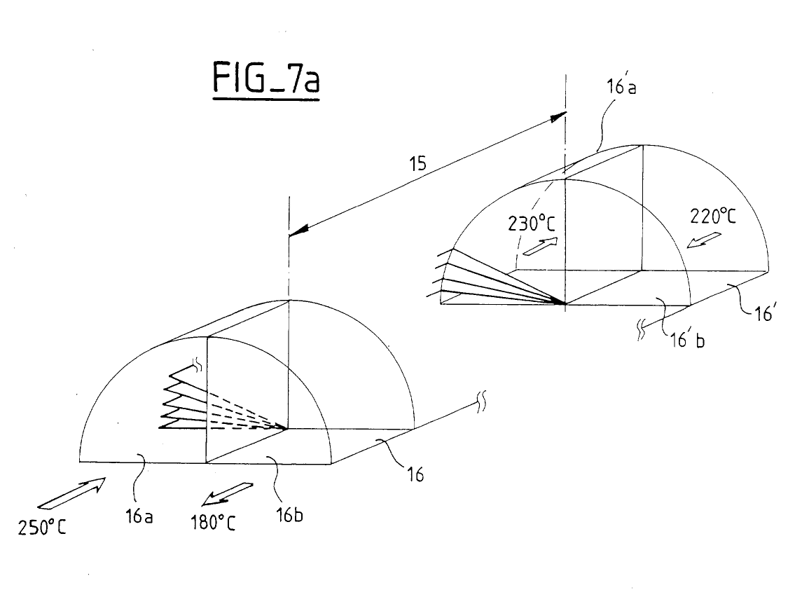

The operation of the drier is very simple. The sheets enter the drier, are placed on the branches, and can then, under the effect of the heat, discharge water. The chamber 15 allows the drying section or zone to be contained. This chamber is in relation with a ventilation circuit, not depicted in the drawing, which, in addition to comprising pipes, comprises one or more heat generators and blowers to cause the hot gases to circulate around the sheets of plasterboard that are to be dried. For example, the chamber 15 may be divided into two or more sections, with air or some other gas circulated between these sections; this is described in greater detail below. FIG. 6a depicts the scenario with one single drying section, while FIG. 6b depicts the scenario where there are two distinct drying sections (different temperatures from one section to the other). The circulation of the gases through the barrel and the chamber will be described in greater detail in FIG. 7.

By comparison with the prior art, this type of drier makes it possible to have better uniformity in the drying. Specifically, in the prior art, the sheets were introduced slowly and in the longitudinal direction, and this caused an offset between runs of sheets, therefore a potential risk of what is known as sheet-end calcination. Furthermore, as the sheets in a run of sheets have different degrees of hydration, drying is affected by this heterogeneity. In the novel method, the sheets are introduced quickly and in the transverse direction, and this avoids the above drawbacks.

Each branch preferably (but not necessarily) comprises comb teeth rather than arms (as opposed to the hydration barrel), because here there is no longer a serious risk of sagging and in order also to allow better heat exchange. It is, however, possible to use arms, particularly ones pierced with a great many holes. The comb tooth has a section in contact with the sheet of, for example, 0.5 to 10 cm, particularly 1 to 8 cm. The barrel comprises, for example, from 20 to 150 branches, preferably from 6 to 120. The dimensions of the barrel are generally as follows: diameter from 3 to 6 m, preferably from 3.5 to 4.5 m, and length from 3 to 25 m, or even more, preferably from 6 to 15 m. In general, two or more drying barrels are used. These barrels preferably have distinct drying sections (so as to optimize the drying process by precise control of the drying curve representing weight loss as a function of time).

The rotational speed of the barrel will be chosen as a function of the number of branches of the barrel, of the line output rate, etc. In general, the rotational speed of the barrel is between 1 rev/h and 6 rev/h, preferably between 2 and 4 rev/h.

The barrel may be partially or entirely placed inside the heated chamber, with a more or less uniform atmosphere in the barrel. However, it will be preferable for the sheets to form the conduits which duct the gas, so as to obtain an “intelligent” flow of these gases through the chamber. This makes it possible to have several drying sections with different profiles, and therefore to optimize the drying. In order to obtain good uniformity of the drying in the lengthwise direction of the sheets, in each drying section thus defined the stream of hot gases will alternately be reversed. This operation is achieved simply, for example, by reversing the direction of operation of the blowers or by installing appropriate deflectors at the ends of the chamber. With this solution, each section comprises an even number of conduits. It is also possible to install burners, for example, at the two ends of the chamber. The circulation circuit may, in particular, be obtained by appropriate cowling, the chamber 15 being divided at the ends of the barrel into as many sections as desired.

The barrel is described with reference to FIG. 7a, and arrows are used to represent the circuit of the hot gases. The chamber is such that the sheets act as deflectors and as guides for the hot gases, parallel to the sheets. It is thus possible, by altering the operating conditions, to obtain two or more drying sections with distinct conditions. In fact, there can be as many drying sections as there are cavities formed by two consecutive sheets.

More specifically, at its two ends the chamber has a cowling 16 and 16′ which is divided into as many sections as there are drying sections. In the example depicted in FIG. 7, there are two drying sections and therefore two compartments at the end cowlings (16a and 16b, and 16′a and 16′b, respectively). The arrows indicate the direction of flow of the hot gases.

For example, it is possible to have two drying sections, one with an entry temperature of about 250° C. and an exit temperature of about 230° C., and another section with an entry temperature of about 220° C. and an exit temperature of about 180° C. It is then possible to apply a greater amount of heat while at the same time being sure of not “burning” or calcining the sheets.

It is also possible and advantageous to have a chicane at the cowlings; in this particular instance, the cowling 16′ would have a chicane which would allow the gases leaving the first section at about 230° C. to be used as gases entering the other section at about 220° C. (or even at the same temperature). This is more apparent in FIG. 7b, a view in section from above, in which the cowling 16′ comprises a chicane 17′ around which the hot gases flow. The circulation of the gases is represented by the arrows.

The invention therefore makes it possible to optimize the drying zones, something which is very difficult, if not impossible, in the prior art. At this stage, it is useful to recollect that the art of drying generally recognizes three zones, zone 1, zone 2 and zone 3. Zones 1 and 2 comprise drying at high gas temperatures (fierce drying) to cause effective migration of starch into the paper and to remove about 80% of the water. Zone 3 is a zone in which drying is gentler, so as to avoid exceeding the board calcination temperature. In this zone, the drying rate is limited by the diffusion of vapour in the core of the board. In general, zones 1 and 2 last, in total, 15 to 30 min (generally less than 45 min) whereas zone 3 lasts for a time that is equivalent to the combined times of zones 1 and 2. The temperatures in these zones are typically those mentioned hereinabove. It should also be noted that the invention makes it possible to obtain, as is sought-after in the prior art, counter-current or co-current drying. The invention therefore makes it possible to obtain a particularly suitable and homogeneous drying profile.

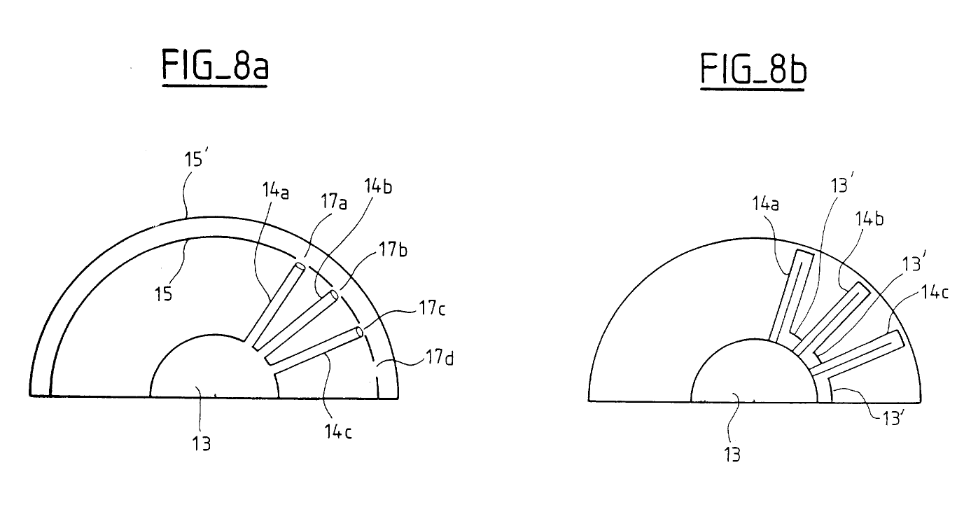

It is possible to conceive of a central drum, this being divided into zones (in the fashion of segments of an orange), each zone being supplied with hot gas independently, making it possible to recreate distinct heating zones. The heating of the boards therefore takes place radially, from the central drum, the hot gases being distributed through orifices arranged on the central drum or through the fingers of the barrel (see, for example, FIG. 8 infra to which this embodiment applies).

It is possible and advantageous to place several barrels in series. The devices for transporting from one barrel to the other have been described above with reference to the hydration barrel. For example, it is possible to have a first barrel, for example of the type described above with two drying sections, and a second barrel with a third drying section. The third drying section has, for example, an entry temperature of about 150° C. and an exit temperature of about 100° C. The barrels in series can very easily be synchronized.

The design of this drier allows a great deal of flexibility as to the type of drying method. The drier described above is of the direct drier type (hot gases in direct contact with the sheets, with a gas velocity vector parallel to the sheets).

An alternative form of direct drying is also possible with this type of drier. Instead of circulating the hot gases between the sheets as indicated in the description, the gases are introduced via the central drum then into the pierced teeth (the teeth are generally such that surface contact with the sheet is minimal whereas the gases escape through holes arranged along the teeth). The shape of the teeth is tailored to this type of drying, namely a rounded shape to prevent the sheets from obstructing the holes and the passage of the gas. This method of jet-type drying has the advantage of having a better heat exchange coefficient and therefore better energy efficiency.

It is also possible to dry the sheets of plasterboard according to the indirect vapour drying method, for example with minor modifications to the barrel. Choosing indirect drying makes it possible to use other fuels which are more economical than gas or light fuel oil, such as coal, heavy fuel oil, wood chip or all kinds of waste that can be burnt in a boiler.

In this configuration, the vapour is introduced into the central axis and then is distributed into the teeth. The vapour condensed by exchange of heat with the sheets is recuperated in the drum or the ring then led back to the boiler. The barrel suited to this type of indirect vapour drying is relatively similar to the one described with reference to FIGS. 8a and 8b below.

Another embodiment is described with reference to FIGS. 8a and 8b. The central axis 13 becomes a drum into which the hot gases laden with water vapour from, in particular, the first sections of the dried or of the previous barrels, are reintroduced. The branches 14a, 14b, 14c consist of hollow comb teeth connected to the central drum. The hot gases laden with water vapour then flow through these comb teeth from the centre outwards, and possibly from the outside towards the centre.

In the alternative form illustrated in FIG. 8a, the gases are collected by the outer chamber through a calibrated orifice, several orifices 17a, 17b, 17c, 17d being (uniformly) distributed about the periphery. The outer chamber in this case consists of a double wall (15, 15′) connected to a blower. When the barrel revolves, since the ends of the teeth are hollow, they regularly come to face the (uniformly) distributed orifices. A stream gas can thus be established.

In the alternative form illustrated in FIG. 8b, the gases travel out and back along the teeth, these being fitted with an internal chicane. They are then collected in a ring 13′ around the central drum.

These gases are indirectly in contact with the sheets placed on the branches. This being the case, the water vapour will condense and, upon contact, give up its latent heat of condensation. The condensed water flows along the comb teeth and is collected in the compartmentalized drum or the ring, from where it is removed preferably by gravity or by means of a pump. Likewise, the water condensed on the double wall of the chamber will be removed by gravity. It would also be possible to envisage collecting the condensed water in the drum and then causing it to flow out through the comb teeth in the lowered position. This technique may also be implemented in accordance with the teaching of document DE-A-4326877. It is thus possible to collect the hot water vapours produced elsewhere during the drying. In fact, the barrels can receive all the conventional energy recuperation systems thus operating as true internal heat exchangers.

FIGS. 8a and 8b therefore depict a barrel that can be used for indirect drying and/or as a heat recuperator, the main difference between these two modes being the amount of heat supplied by one or more burner(s).

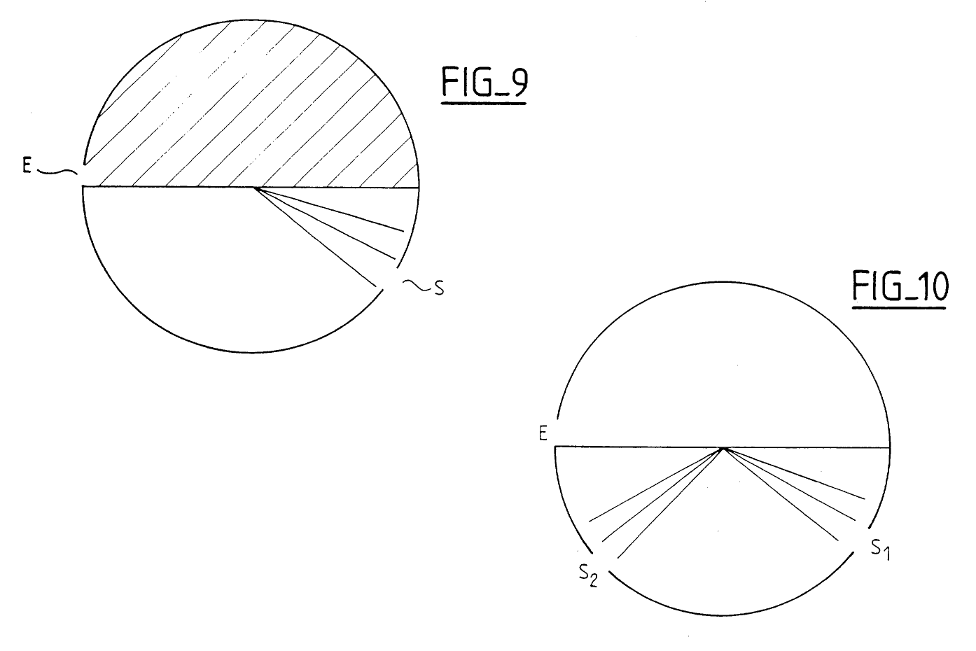

A drier barrel which further comprises a function of cooling the sheets, still with a sheet introduction zone (E), particularly introducing the sheets horizontally, and an exit, is described with reference to FIG. 9. The hatched zone here represents the drying section. The barrel therefore has, for example at the chamber, an additional quarter. For example, the exit (S) in the form of an aperture to the outside is not arranged horizontally, but downwards. In this additional quarter, the sheet can cool naturally or otherwise, in order to avoid any possible thermal shock. The sheet obtained is thus of better quality than with a conventional drier. In addition, as the aperture is offset, the sheet slides out naturally onto a conveyor belt situated beneath.

This quarter could also be above the horizontal, the cooled sheet then leaving horizontally, for example onto a transfer belt.

It might also be possible to provide one (or more) complete barrel(s) for cooling purposes, if necessary.

There is thus obtained at exit from the last barrel a cooled sheet that can be sent directly to the final conditioning zone without passing through the series of bulky and noisy equipment items conventionally found at the exit of a drier, namely the train that groups together the sheets coming from the various stages, the acceleration and stop zones, the transfer tables, etc.

The drying barrels may, just like the hydration barrel, accept different lengths of sheet. In the case of the drying barrel, in order to obtain even better routing of the gases through the cavities, it is possible for example to arrange the sheets alternately, that is to say to have one sheet edge-to-edge on one side of the barrel and the other edge-to-edge on the other side. It is also and preferably possible to use branches which, at their ends (at the lateral discs of the barrel), have segments having sufficient area that each sheet rests on this segment, regardless of its length, and/or which have an appropriate shape (for example in the form of a deflector) to avoid any possible sheet-end calcination likely to occur as a result of the blown hot gases.

The use of barrels, particularly for drying, makes it possible to place all the drive members outside the chamber and therefore protect them from a hot and damp environment which is aggressive.

It will be noted that it is particularly advantageous to couple at least one hydration barrel to at least one drying barrel. In particular, in this case, use will be made of two or three drying barrels, preferably the first (and the second) with one or two distinct drying sections and the last preferably with recuperation of heat. It is also possible in this instance to use a drier of the indirect type.

Incidentally, the barrel is also useful for handling the sheet under gentle conditions.

FIG. 10 depicts a barrel used for turning a sheet over, still under gentle conditions, therefore getting around the use of the turning-over flipper conventionally used. The turning-over operation may be applied to all the sheets, and may be alternated; one sheet being extracted just under the horizontal and another about 180° after, still just under the horizontal. It is thus possible to alternate turning-over of the sheets, which may be useful for packaging sheets ivory faces together.

In the embodiment depicted in FIG. 10, there is an entry (E) as in FIG. 9, and two exits (S1) and (S2). It is possible to extract all the sheets at the exit (S1), but it is also possible to extract them alternately from (S1) and (S2), which leads to sheets which are already alternating (which for example makes dry transfer for ivory face/ivory face pairing easier). When the sheets are handled in the upper part of the barrel, they rest partially on the central hub or drum. When the sheets are handled in the bottom part of the barrel (particularly between the exits (S1) and (S2)), they can slide along the chamber or any other appropriate rail or alternatively be accompanied in their movement by a belt, the linear speed of which corresponds to the speed of the sheet in question at the circumference of the barrel. (These belts will preferably have a path along this circumference).

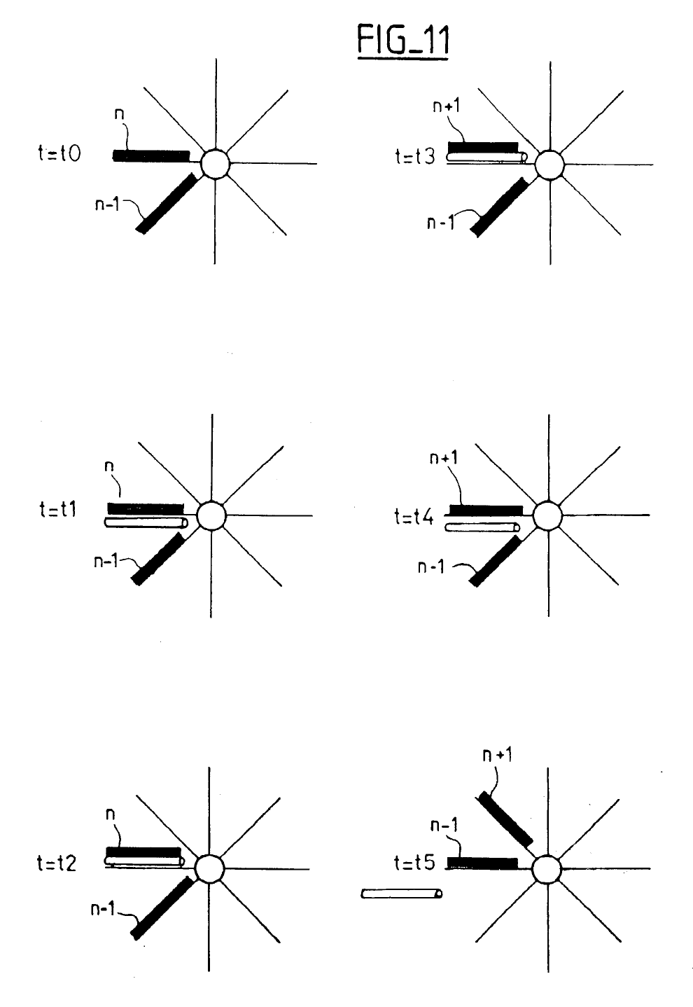

With reference to FIG. 11, this figure describes an embodiment in which the sheets are supplied to the barrels (hydration, drying, cooling, handling). According to this embodiment, the boards are brought in along the axis of the barrels, the direction of travel being along the same line (unlike in the previous embodiments in which supply was by translation once the board had been brought in on the side of the barrels. Schematically, the sequence is as follows. The description is given using one board, for convenience, but the embodiment applies to a string of boards in the same way; the description is given in cross section, the boards arriving in the direction perpendicular to the page. At the instant t=0, the barrel is in the initial position; the board n is on an arm or branch of the barrel, and has just completed a revolution in the barrel. At t=t1, a mechanism made up of a set of rollers (for example) comes in under the board n (for example by translation)—just one roller is depicted in the figure, the others in fact being hidden given the depiction chosen. At t=t2, this mechanism is raised, the rollers fit in between the arms or branches of the barrel, and the effect of this is that the board n no longer rests on the arms or branches of the barrel. At t=t3, the board n+1 coming in along the axis of the barrel replaces the board n by pushing it or by means of the motorized rollers, the boards n and n+1 travelling along the rollers. At t=t4, the mechanism is lowered again, and the effect of this is that the board n+1 rests on the arms or branches of the barrel. At t=t5, the mechanism retracts on the side of the barrel, thus allowing the latter to rotate through the desired angle so as to bring the board n−1 into the starting position of the method according to the specific embodiment.

It is thus possible (as it was in other embodiments) to use the entirety of the barrel, namely 360° to perform the required operations (hydration, drying, cooling, handling). During the part of the rotation that takes place in the lower part of the barrel, the boards may for example be held by returns on the arms or branches, or simply be guided by an external fairing or may alternatively be guided on a caterpillar track arranged on the lower part, this caterpillar track accompanying the movement of the boards.

In this embodiment, known as the “360° embodiment”, the abovementioned data relating to the residence time, the rotational speed, etc. need to be adapted (for example, for the same residence time, the rotational speed may be halved in that all 360° of the barrel rather than just 180° are actually being used). Likewise, for drying, zones 1, 2 and 3 can be grouped together into one single barrel if desired.

Finally, it will be noted that the invention can be applied in general:

in the case of sheets of plasterboard, to any sheet handling operation, including turning over.

in the case of drying, to any type of flat object, particularly, but non-limitingly, plasterboard tiles, tiles (for example made of cement or of clay), etc. or an object for which there is a reaction of a water-based binder. In the lattermost instance, “drying” is to be understood in fact to cover any reaction capable of leading in particular to hardening, such as firing. There is not necessarily any removal of water, but there may be some other type of reaction with the release of other effluents, gaseous or otherwise. For example, curing may be envisaged in the case of cement board. It is to be noted that, in these cases of curing, there is always a concern to have, for most of the time, at least two “drying” periods or phases. This is because it is recognized that for these boards to harden, several steps are used, including: step (1): a step of resting to allow setting to begin before heat is applied; step (2): a heating step with a relatively gentle gradient up to the maximum temperature, possibly with moisture added; step (3): a hold step to ensure the homogeneity of the heating and of the temperature of the parts in the chamber; step (4): ventilation with hot air then ambient air to dehumidify the chamber prior to unloading. The invention makes it possible to obtain a specific profile during curing. The invention also makes it possible to obtain FIFO (First In, First Out) chambers which are reliable and do not present risks of stoppages in the method.

The invention is also aimed at all combinations of one or more hydration barrels, and it is possible to have one or more drying barrels (with one or more drying sections, with or without recuperation of heat), one or more cooling barrels, or one or more handling barrels. The number of barrels and/or the number of sections are not in any way limiting of the present invention. For example, it is possible to have just one hydration barrel, just as it is possible to have two or more of them. It is possible to have one (or more) hydration barrel(s) associated with one (or more) drying barrel(s) and/or cooling barrel(s) and/or handling barrel(s); it is also possible to have just drying barrels; these may be associated with cooling and/or handling barrels. It is possible to have just one drying barrel, just as it is possible to have two, three or more of these. Each barrel may have just one drying section, but it may just as easily have two, three or more of these. Each barrel may be with heating of the direct or indirect type. One or more barrels may be of the heat recuperator type. It is possible to combine all these types (function/construction) of barrel together; all combinations are permitted. The invention applies in particular to the case of the combination of hydration barrel(s) followed by drying barrel(s), it being possible for all embodiments as recalled hereinabove to be combined.

The advantages afforded by the invention are therefore, in particular:

In terms of the method and quality conferred on the sheet:

a hydration time which is practically identical for all the sheets entering the drier;

the elimination of the offset between sheets at the entry to the drier;

the elimination of sheet-end calcination;

the possibility of multiplying the number of drying sections in order to get close to the ideal drying profile;

the possibility of incorporating a cooling zone into the device;

the possibility of easily recuperating the latent heat of condensation in the last drier;

the flexibility in choosing the drying method (direct or indirect or a combination of the two) according to the cost of the energy;

the possibility of handling wet sheet within a shorter period of time than in conventional lines;

there is no longer any breakage or deterioration of the sheet through rapid or rough handling or by knocking against the stops.

In terms of investment:

a reduction in the cost of the wet transfer and partly in the cost of the dry transfer, which are incorporated into the equipment;

a reduction in the cost of the forming line, because it is shorter and/or because it uses shears of a simpler design;

a simpler drier (no moving parts) which is also smaller;

an installation which is flexible in terms of capacity by altering the length, the number of barrels or the number of branches per barrel; this makes it possible to augment capacity for low investment and with quick installation;

there is a reduction in land and building occupancy;

the addition of the device for recuperating the latent heat of condensation of the water vapour which is far less expensive than with a conventional drier (practically incorporated into the principle).

In terms of maintenance:

a reduction in the cost of maintenance on the wet and dry transfers;

a reduction in the costs on the drier, because the motorization and drive system can be outside the hot damp part of the drier; there are fewer moving parts;

the elimination of the use of compressed air in this equipment.

In terms of operating cost:

a reduction in the energy for drying by the system for recuperating the latent heat of condensation of the water vapour;

a reduction in the electrical power consumption (the installed power for motorizing the drive is divided by 3 to 4);

a reduction in the consumption of compressed air (on the transfer tables) and in the associated maintenance;

a reduction in the cost of drying by the use of a less expensive fuel, in the case of indirect drying;

an improvement in the extent to which the equipment is used.

In terms of safety and working conditions:

reduction in the noise, particularly on the two transfers and by the elimination of the train at the drier exit. No more noise associated with the use of compressed air on the transfer tables;

safety: fewer high-speed moving parts either in terms of rotation (rollers) or in terms of translation (up and down table).

It should be noted that the invention applies generically to individual sheets as well as to runs of sheets. The terms forming, shearing, hydration, drying, etc. of “the sheet” are also intended to be understood as referring to “the sheets of the run of sheets”.

It should also be noted that the term “sheet of plasterboard” used in the invention covers sheets based on plaster, particularly, but non-limitingly, sheets with one or more paper or cardboard facings (known as “wall-board”, “plaster-board”), and also of other materials such as a mat of fibreglass (sheets of what is known as “fire-resistant plasterboard”), sheets known as “fibre-board”, etc. The invention applies preferably to sheets with a board facing (to “plaster-board”).

The invention is not restricted to the embodiments described but can be varied in numerous ways easily accessible to those skilled in the art.

1. A method for manufacturing a sheet of plasterboard, the method comprising:
(i) forming the sheet
(ii) setting the sheet with hydration
(iii) drying the sheet while the sheet is being rotated.

2. The method according to claim 1, in which drying is carried out in at least one barrel revolving inside a chamber.

3. The method according to claim 1, in which drying is carried out in at least one barrel, the at least one barrel comprising a single drying section.

4. The method according to claim 1, in which drying is carried out in at least one barrel, the at least one barrel comprising two distinct drying sections.

5. The method according to claim 1, in which drying is carried out in at least one barrel, the at least one barrel comprising three or more distinct drying sections.

6. The method according to claim 1, in which drying is carried out in at least two barrels.

7. The method according to claim 6, wherein drying sections are distinct from one barrel to the next.

8. The method according to claim 6, in which each barrel may comprise one, two, three or more distinct drying sections.

9. The method according to claim 1, in which drying is carried out in at least one barrel, with latent heat of condensation of the water recuperated.

10. The method according to claim 9, in which drying is carried out in at least one first barrel without recuperation and in at least another barrel with recuperation.

11. The method according to claim 1, further comprising cooling the sheet.

12. The method according to claim 11, in which the cooling is partially carried out in part of a last barrel.

13. A method for manufacturing a sheet of plasterboard, the method comprising:
(i) forming the sheet
(ii) setting the sheet with hydration
(iii) drying the sheet while the sheet is being rotated, said drying being carried out in at least one barrel revolving inside a chamber, the at least one barrel comprising at least two distinct drying sections.

14. A device for manufacturing a sheet of plasterboard, the device comprising a forming zone, a setting and hydration zone and at least one barrel comprising a central axis about which a number of branches are arranged, the barrel being contained in a chamber.

15. The device according to claim 14, in which each branch is divided into a number of comb teeth.

16. The device according to claim 14, in which the chamber represents a single drying section.

17. The device according to claim 14, in which the chamber is divided into two distinct drying sections.

18. The device according to claim 14, in which the chamber is divided into three or more distinct drying sections.

19. The device according to claim 15, in which the central axis is a drum and the teeth are hollow in relation to the said drum.

20. The device according to claim 15, in which the central axis is a drum and the teeth are hollow, in relation to the said drum, and pierced with holes along these.

21. The device according to claim 14, comprising at least one barrel without recuperation and at least another barrel for recuperating the latent heat of condensation of the water.

22. The device according to claim 14, in which the barrel has a cooling zone.

23. The device according to claim 22, in which the cooling zone corresponds to a quarter of the barrel situated under a horizontal median, the chamber being arranged at this zone.

24. The device according to claim 22,in which the cooling zone corresponds to a quarter of the barrel situated above the horizontal median, the chamber possibly being arranged at this zone.

25. A device for manufacturing a sheet of plasterboard, the device comprising a forming zone, a setting and hydration zone and at least one barrel comprising a central axis about which a number of branches are arranged, the said barrel being contained in a chamber, each branch being is divided into a number of comb teeth, said at least one barrel comprising at least two distinct drying sections.

26. The device according to claim 14 for the implementation of a method for manufacturing a sheet of plasterboard, the method comprising:
(i) forming the sheet;
(ii) setting the sheet with hydration
(iii) drying the sheet while the sheet is being rotated.

27. The device according to claim 25 for the implementation of a method for manufacturing a sheet of plasterboard, the method comprising:
(i) forming the sheet;
(ii) setting the sheet with hydration;
(iii) drying the sheet while the sheet is being rotated, said drying being carried out in at least one barrel revolving inside a chamber, the at least one barrel comprising at least two distinct drying sections.

28. A barrel comprising a central axis about which a number of branches are arranged, each branch being divided into a number of comb teeth, the said barrel being contained in a chamber.

29. The barrel according to claim 28, in which the chamber represents a single drying section.

30. The barrel according to claim 28, in which the chamber is divided into two distinct drying sections.

31. The barrel according to claim 28, in which the chamber is divided into three or more distinct drying sections.

32. The barrel according to claim 28, in which the central axis is a drum and the teeth are hollow in relation to the said drum.

33. The barrel according to claim 28, in which the central axis is a drum and the teeth are hollow, in relation to the said drum, and are pierced with holes along these.

34. The barrel according to claim 28, further comprising a cooling zone.

35. The barrel according to claim 34, in which the cooling zone corresponds to a quarter of the barrel situated under a horizontal median, the chamber being arranged at this zone.

36. The barrel according to claim 34, in which the cooling zone corresponds to a quarter of the barrel situated above a horizontal median, the chamber being arranged at this zone.
